(19) United States
(12) Patent Application Publication
(10) Pub. No.: US 2009/0286675 A1
(43) Pub. Date: Nov. 19, 2009

(54) CONTINUOUS MASS PRODUCTION OF CARBON NANOTUBES IN A NANO-AGGLOMERATE FLUIDIZED-BED AND THE REACTOR

(75) Inventors: Fei Wei, Beijing (CN); Yao Wang, Beijing (CN); Guohua Luo, Beijing (CN); Hao Yu, Beijing (CN); Zhifei Li, Beijing (CN); Weizhong Qian, Beijing (CN); Zhanwen Wang, Beijing (CN); Yong Jin, Beijing (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Tsinghua University, Beijing (CN)

(21) Appl. No.: 12/400,713

(22) Filed: Mar. 9, 2009

Related U.S. Application Data
(63) Continuation-in-part of application No. 10/478,512, filed on Nov. 24, 2003, now Pat. No. 7,563,427.

(30) Foreign Application Priority Data
May 25, 2001 (CN) 01118349.7

(51) Int. Cl. B01J 21/18; B82B 1/00

(52) U.S. Cl. 502/184; 502/182; 502/185; 977/742

(57) ABSTRACT

The present invention relates to a method for continuous production of carbon nanotubes in a nano-agglomerate fluidized bed, which comprises the following steps: loading transition metal compounds on a support, obtaining supported nanosized metal catalysts by reducing or dissociating, catalytically decomposing a carbon-source gas, and growing carbon nanotubes on the catalyst support by chemical vapor deposition of carbon atoms. The carbon nanotubes are 4˜100 nm in diameter and 0.5˜1000 μm in length. The carbon nanotube agglomerates, ranged between 1˜1000 μm, are smoothly fluidized under 0.005 to 2 m/s superficial gas velocity and 20-800 kg/m³ bed density in the fluidized-bed reactor. The apparatus is simple and easy to operate, has a high reaction rate, and it can be used to produce carbon nanotubes with high degree of crystallization, high purity, and high yield.

### CROSS-REFERENCES TO RELATED APPLICATIONS

This application is a continuation-in-part of U.S. application Ser. No. 10/478,512 filed Nov. 24, 2003, which is a National Stage Entry of PCT/CN02/00044 filed Jan. 29, 2002 which claims benefit of priority to Chinese Patent Application No. CN 01118349.7 filed May 25, 2001.

### BACKGROUND OF THE INVENTION

It is more than a decade since the first report on carbon nanotube as a new material. The exceptional mechanical and electrical properties of carbon nanotube have attracted intensive attention of physicists, chemists and material scientists worldwide, however, its commercial application has not been realized yet. The reasons lie in two interrelated aspects: the difficulty in mass production of carbon nanotubes and hence the high production cost. For instance, the international market price of carbon nanotubes of 90% purity is as high as $60/g, which is 5 times that of gold. It is reported that the highest production rate of carbon nanotubes till now is only 200 g/h (MOTOO YUMURA et al., CNT10, October 2001, p. 31). There are also reports forecasting that industrial application of carbon nanotubes will remain unpractical until its price falls below $2/pound, i.e. 0.4 cent/g, and it needs a production rate of 10,000,000 pound per year or about 12.5 tons per day to bring the price down to this level. Thus, in order to take carbon nanotubes from laboratory to market, mass production of high-quality carbon nanotubes is one of the principal challenges to take.

Novel process and reactor technology are the keys to the mass production of carbon nanotubes. Known methods for the preparation of carbon nanotubes mainly comprise graphite arc-discharge method, catalytic arc-evaporation method and catalytic decomposition method, of which the catalytic decomposition method is the most prevalent, especially the catalytic decomposition of lower hydrocarbons. The production of carbon nanotubes by chemical vapor deposition is a process involving both a typical chemical engineering process and the special preparation process of nanometer materials. Thus a desired production method should meet the requirements of heat transfer and mass transfer in the chemical engineering process while taking the special properties of nano-materials into consideration. Carbon nanotubes are one-dimensional nano-materials that grow during the reaction, and which demand a catalyst with its active ingredients dispersed on the nano-scale and which need sufficient space for growth. For a high rate of reaction, an appropriate concentration of catalysts is also necessary.

The gas-solid fluidization technique is an efficient measure to intensify the contact between gases and solids and has been widely used in many fields, and it is particularly suitable for the preparation, processing and utilization of powders. The gas-solid fluidization technique offers many advantages, such as high throughput, large capacity of transporting/supplying heat, and easy transfer of powder products and catalysts. However, traditional gas-solid fluidized beds are only used for the fluidization of non-C-type powders with diameters larger than 30 μm (Geldart D. Powder Technology, 1973, 7: 285). The growth of one dimensional materials and their adherence to each other in the preparation of carbon nanotubes by chemical vapor deposition tend to make fluidization difficult, and thus cause coagulation, uneven distribution of temperature and concentrations, and the deposition of carbon among particles. Therefore, there has been no report on the application of fluidized-bed reactor in continuous mass production of carbon nano-materials.

It is now known that the inter-particle forces among fine powders do not monotonically increase with the decrease of particle sizes. The intense Van der Waals force among nanometer particles can be effectively weakened in some nanomaterial systems by the formation of structurally loose agglomerates by the self-agglomeration of primary particles, which makes the said nano-materials fluidized and capable of flowing in the form of agglomerates. Chaouki et al. (Powder Technology, 1985, 43: 117) have reported the agglomerate fluidization of a Cu/Al₂O₃ aerogel. Wang et al. (Journal of Tsinghua University, Science and Technology Engineering, vol. 41, No. 4/5, April 2001, p 32-35) investigated the particulate fluidization behaviors of SiO₂ nano-agglomerates. The agglomerate fluidization of carbon fibers was also reported by Brooks (Fluidization V, New York: Engineering Foundation, 1986, pp 217).

### BRIEF SUMMARY OF THE INVENTION

The object of the present invention is to provide a method and reaction apparatus for continuous production of carbon nanotubes in a nano-agglomerate fluidized bed, wherein the agglomeration and aggregation behaviors of nano-particles are taken into consideration. Normal fluidization state or even particulate fluidization state can be realized and maintained during the whole reaction process through proper control of the structure and growth of carbon nanotubes based on the analysis of the growth, agglomeration and fluidization of carbon nanotubes during the chemical vapor deposition process. By properly adjusting the reaction rate, operating conditions and fluidized-bed structure, the reactor bed is kept in an agglomerate fluidization state, so as to realize the continuous mass production of carbon nanotubes with a high degree of crystallization, high purity, and high yield. In certain instances, the carbon nanotubes produced have a purity of greater than 96% and a yield of greater than >26 g/per gram of catalyst.

The present invention provides a method for continuous production of carbon nanotubes in a nano-agglomerate fluidized bed, which comprises the following steps:

1. loading transition metal oxide on a support;

2. adding said transition metal oxide catalyst into a catalyst activation reactor, flowing a mixture of nitrogen and hydrogen or carbon monoxide into the reactor at 500˜900° C. to reduce the nanosized transition metal oxide particles to nanosized metal particles, wherein the volume ratio of hydrogen or carbon monoxide to nitrogen is from 1:0.3 to 1:1, the space velocity during the reduction reaction is from 0.3 h⁻¹ to 3 h⁻¹ and the catalyst is in the form of nano-agglomerates, which have diameters between 1˜1000 μm;

3. transporting the catalyst into a fluidized-bed reactor, flowing a mixture of hydrogen or carbon monoxide, a gas of lower hydrocarbons having less than 7 carbon atoms, and nitrogen into the reactor at 500˜900° C., with the volume ratio of hydrogen or carbon monoxide:carbon-source-gas:nitrogen equals 0.4˜1:1:0.1˜2, wherein the space velocity during the reaction is 5˜10000 h⁻¹, the superficial gas velocity is 0.08˜2 m/s, the bed density is maintained at 20˜800 kg/m³, and the nano-agglomerates of the catalyst and the carbon nanotube product are kept in a dense-phase fluidization state, as a result, carbon nanotubes are obtained from the fluidized-bed reactor.

The process can be operated continuously when the catalyst and the reactants are fed continuously and the product is continuously removed out from the reactor.

According to the present invention, a second method for continuous production of carbon nanotubes in a nano-agglomerate fluidized bed comprises the following steps:

1. placing a catalyst support in the fluidized bed reactor, wherein the diameters of the agglomerates of the catalyst support are in the range of 1˜1000 μm and the bed density of the reactor is 20˜1500 kg/m³ so that the catalyst support can be fluidized;

2. dissolving a metallocene compound in a low carbon number organic solvent;

3. heating the above solution to a temperature higher than the boiling point of the organic solvent to vaporize the solution;

4. feeding the above vaporized catalyst precursor into the fluidized-bed reactor, flowing a mixture of hydrogen or carbon monoxide, a gas of lower hydrocarbons having less than 7 carbon atoms, and nitrogen into the reactor at 500˜900° C., with the volume ratio of hydrogen or carbon monoxide:carbon-source-gas:nitrogen equals 0.4˜1:1:0.1˜2, wherein the space velocity during the reaction is 5˜10000 h⁻¹, the superficial gas velocity is 0.005˜2 m/s, and the stuffs in the reactor are kept in a dense-phase fluidization state, as a result, carbon nanotubes are obtained from the fluidized-bed reactor.

The present invention also provides a reaction apparatus for the continuous production of carbon nanotubes in a nano-agglomerate fluidized bed, which comprises a main reactor, a catalyst activation reactor, a gas distributor, a gas-solid separator and a product degassing section. The catalyst activation reactor is connected to the main reactor, the gas distributor is placed at the bottom of the main reactor, the gas-solid separator is arranged at the top of the main reactor, heat exchange tubes are provided inside the main reactor, and means for feeding gases are provided at the bottom of the main reactor, and the product degassing section is connected to the main reactor.

In the second method of the invention, due to the use of a metallocene compound as the catalyst precursor, the catalyst activation reactor can be omitted and the metallocene compound is directly fed into the main reactor containing the catalyst support, so that catalyst preparation and the main reaction are integrated.

According to the present invention, the catalyst and the carbon nanotube product, which exist in the form of agglomerates during the process, are kept in a state of good flowability/fluidization by control of the operation conditions.

The catalyst support can be selected from powders with good flowability, such as superfine glass beads, silicon dioxide, alumina and carbon nanotubes. By adopting the process, conditions and reactors of the present invention, carbon nanotubes having a loose agglomerated structure can be produced with agglomerate diameters of 1˜1000 μm, bulk density of 20˜800 kg/m³, and with good flowability/fluidization properties.

The reaction apparatus of the present invention has the following outstanding characteristics:

1. It makes good use of the specific characteristics of the fluidized bed, and it has compact structure and good applicability.

2. The stuffs in the reactor are of an appropriate density such that they can be kept in a state of flow/fluidization, and this provides sufficient growing space for the carbon nanotubes and also obtains sufficient reaction capacity.

3. It can continuously supply the catalyst into and remove the carbon nanotube product out of the reactor, thus a continuous mass production can be achieved.

4. During the production of the nanosized carbon materials, the distribution of temperature and concentrations in the fluidized bed are uniform, and there is neither local overheating nor coagulation.

5. It can supply heat in and remove heat out of a scaled-up apparatus, and is suitable for the exothermic or endothermic catalytic decomposition processes. 6. The adaptability of the reactor system is excellent. The locations of the feed inlet and product outlet can be adjusted according to the requirements of the reaction residence time and the structure of the products.

### BRIEF DESCRIPTION OF THE DRAWINGS

FIG. 1 is a schematic diagram of the structure of the reaction apparatus of the present invention. In FIG. 1, 1 is the main reactor, 2 is the gas distributor, 3 is the heat exchanger, 4 is the inlet for the catalyst, 5 is the outlet for the product, 6 is the catalyst activation reactor, 7 is the gas-solid separator, 8 is the gas feed device, 9 is the product degassing section.

FIG. 2 is a Scanning Electron Microscope (SEM) photograph of the carbon nanotube agglomerate produced using the method and reaction apparatus of the present invention.

FIG. 3 is a Transmission Electron Microscope (TEM) photograph of the carbon nanotubes produced using the method and reaction apparatus of the present invention.

FIG. 4 is a High Resolution Transmission Electron Microscope (HRTEM) photograph of the carbon nanotubes produced using the method and reaction apparatus of the present invention.

FIG. 5 shows the growth mechanism of carbon nanotube agglomerates with catalysts.

FIG. 6 shows carbon nanotube agglomerates under different magnifications. 6a: carbon nanotube agglomerates with an average diameter of about 100 microns. 6b: shows the large spherical agglomerates is actually a composite agglomerate with hundreds of nano simple agglomerate in an adhesion formation. 6c: shows that the entanglement of interwoven carbon nanotubes within the nano-sized simple agglomerates.

FIG. 7 shows a multi-level agglomerate structure of carbon nanotubes.

### DETAILED DESCRIPTION OF THE INVENTION

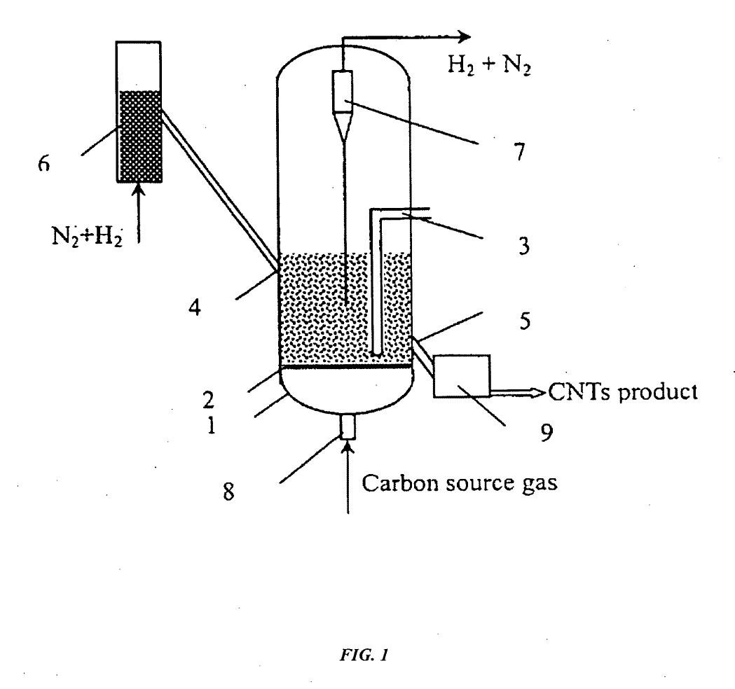

As shown in FIG. 1, according to the present invention, the reaction apparatus for the continuous production of carbon nanotubes in a nano-agglomerate fluidized bed comprises a main reactor 1, a catalyst activation reactor 6, a gas distributor 2, a gas-solid separator 7 and a product degassing section 9. The catalyst activation reactor 6 is connected to the main reactor 1, the gas distributor 2 is placed in the bottom of the main reactor 1 and the gas-solid separator 7 is arranged at the top of the main reactor 1, the main reactor 1 is provided with heat exchange tubes 3 and means for feeding gases at its bottom, and the product degassing section 9 is connected to the main reactor 1 through a product outlet 5. The product outlet 5 can be used to adjust the amount of the stuffs in the main reactor. The product outlet 5 is connected to the product degassing section 9 for desorbing the organic materials absorbed on the product.

The contents of the present invention are described in details by the following examples. However, the examples are not intended to limit the scope of the invention.

### Example 1

1. Loading Fe—Cu transition metal oxides on a SiO₂ support.

2. Adding the above supported catalyst into the catalyst activation reactor and carrying out the reduction reaction by flowing a mixture of hydrogen and nitrogen into the reactor at 650° C., wherein the volume ratio of hydrogen to nitrogen was 1:0.5 and the space velocity of the reduction reaction was 0.5 h⁻¹.

3. Transporting the reduced catalyst into the fluidized bed with temperature at 700° C., feeding a mixture of hydrogen, ethylene and nitrogen into the reactor, wherein the volume ratio of H₂:C₂H₄:N₂ was 1:1:1 and the space velocity during the reaction was kept at 10000 h⁻¹ and the superficial gas velocity was 0.5 m/s.

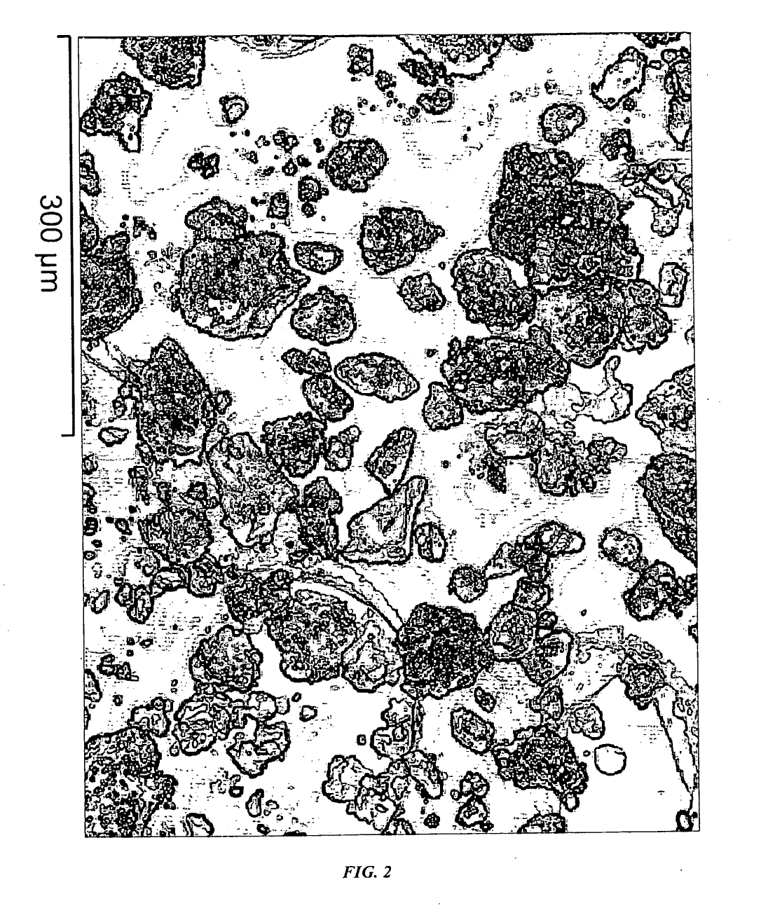

FIG. 2 shows a typical SEM photo of the carbon nanotubes produced in the example 1. The sample was directly obtained from the reactor and was not subjected to any purification nor pulverization. The carbon nanotubes are in the form of agglomerates, and most of the agglomerates are near spherical in shape with diameters of less than 100 μm.

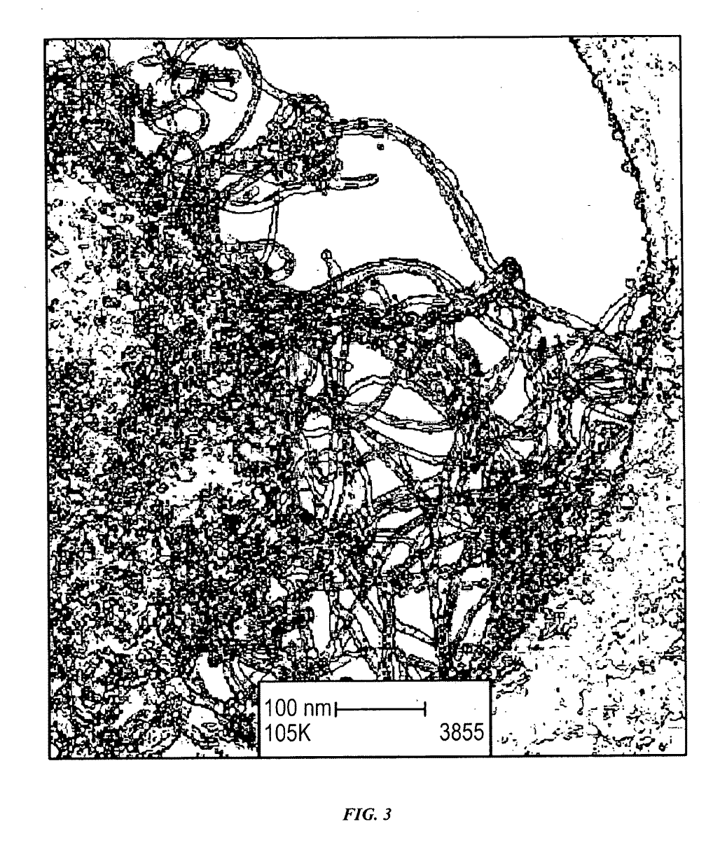

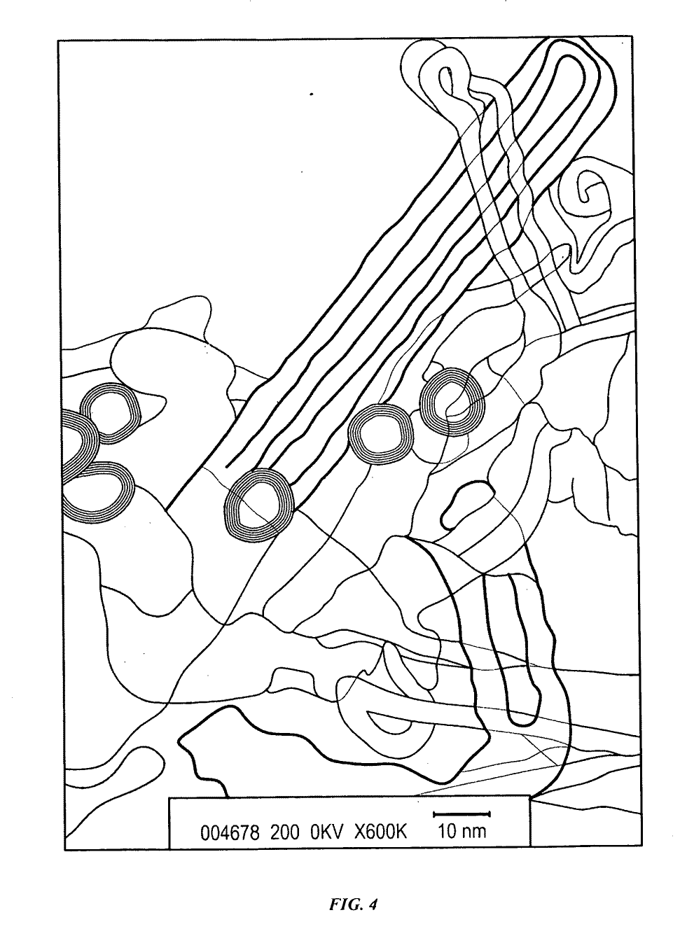

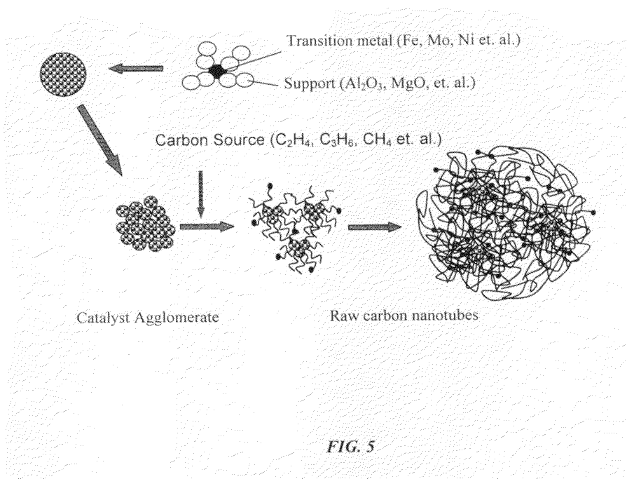

FIG. 3 shows a TEM photo of the above-mentioned sample. During sample preparation, a small quantity of the unpurified sample was dispersed in ethanol by ultrasonic wave, and then dripped onto a fine copper grid for Transmission Electron Microscopy observation. It can be seen from the figure that the carbon nanotubes are quite pure and have diameters of less than 10 nm, and the tubes are long and uniform in diameter.

FIG. 4 is a HRTEM photo of the sample, which was prepared by the same procedure as that for FIG. 3. From the figure, the carbon atom layers of the multi-wall carbon nanotube can be observed.

### Example 2

1. Loading Ni—Cu transition metal oxides on a glass bead support.

2. Adding the above supported catalyst into the catalyst activation reactor and carrying out the reduction reaction by flowing a mixture of hydrogen and nitrogen into the reactor at 520° C., wherein the volume ratio of hydrogen to nitrogen was 1:1 and the space velocity of the reduction reaction was 2 h⁻¹.

3. Transporting the reduced catalyst into the fluidized bed with temperature at 520° C., feeding a mixture of hydrogen, propylene and nitrogen into the reactor, wherein the volume ratio of H₂:C₃H₆:N₂ is 1:1:1 and the space velocity during the reaction was kept at 5 h⁻¹ and the superficial gas velocity was 0.09 m/s.

### Example 3

1. Loading Co—Mn transition metal oxides on a Al₂O₃ support.

2. Adding the above supported catalyst into the catalyst activation reactor and carrying out the reduction reaction by flowing a mixture of hydrogen and nitrogen into the reactor at 800° C., wherein the volume ratio of hydrogen to nitrogen was 1:0.5 and the space velocity of the reduction reaction was 0.3 h⁻¹.

3. Transporting the reduced catalyst into the fluidized bed with temperature at 870° C., feeding a mixture of hydrogen, methane and nitrogen into the reactor, wherein the volume ratio of H₂:CH₄:N₂ was 0.5:1:0.1 and the space velocity during the reaction was kept at 5000 h⁻¹, and the superficial gas velocity was 0.8 m/s.

### Example 4

1. Loading Ni transition metal oxide on a Al₂O₃ support.

2. Adding the above supported catalyst into the catalyst activation reactor and carrying out the reduction reaction by flowing a mixture of carbon monoxide and nitrogen into the reactor at 870° C., wherein the volume ratio of carbon monoxide to nitrogen was 1:0.5 and the space velocity of the reduction reaction was 3 h⁻¹.

3. Transporting the reduced catalyst into the fluidized bed with temperature at 870° C., feeding a mixture of hydrogen, ethylene and nitrogen into the reactor, wherein the volume ratio of H₂:C₂H₄:N₂ was 1:1:0.5 and the space velocity during the reaction was kept at 8000 h⁻¹ and the superficial gas velocity was 1.3 m/s.

### Example 5

1. Loading Ni—Cu transition metal oxides on a Al₂O₃ support.

2. Adding the above supported catalyst into the catalyst activation reactor and carrying out the reduction reaction by flowing a mixture of hydrogen and nitrogen into the reactor at 870° C., wherein the volume ratio of hydrogen to nitrogen was 1:0.5 and the space velocity of the reduction reaction was 0.5 h⁻¹.

3. Transporting the reduced catalyst into the fluidized bed with temperature at 870° C., feeding a mixture of hydrogen, methane and nitrogen into the reactor, wherein the volume ratio of H₂:CH₄:N₂ was 1:1:0.5 and the space velocity during the reaction was kept at 9000 h⁻¹, and the superficial gas velocity was 1.7 m/s.

### Example 6

1. Carbon nanotubes were placed in the main reactor as catalyst support.

2. Dissolving ferrocene in benzene, vaporizing the solution, and then feeding the obtained vapor together with propylene and nitrogen into the main reactor at 650° C., wherein the volume ratio of propylene:nitrogen:benzene:ferrocene equals 1:0.3:0.2:0.02, the superficial gas velocity was 0.1 m/s and the space velocity was 200 h⁻¹, the ferrocene was dissociated to form metal nano-particles supported on the carbon nanotube supports, and under the catalytic action of the metal nano-particles, the carbon-source gas was decomposed and new carbon nanotubes were obtained.

### Example 7

Forming nano-agglomerates is a critical step for growth of carbon nanotubes in a fluidized-bed reactor. Nano-agglomerates are defined as agglomerates, which have a dimension of 1-1000 micron meters, are composed of nano scale materials in an aggregated structure. The presence of the nano-agglomerates is the key characteristic in nano-agglomerate fluidized-bed in mass production of carbon nanotubes. FIG. 5 shows the growth mechanism of carbon nanotube agglomerates with catalysts. The catalysts used are supported nano-size metals or metal oxides. The catalyst agglomerates are composite of many nano-scale catalyst particles (typically, transition metals such as Fe, Mo, Ni, Co and et. al. on an oxide support, such as SiO₂, Al₂O₃ or MgO). The typical diameter of the catalyst agglomerates is from 1 to 1000 micron meters. During the catalytic growth of carbon nanotubes with the introduction of carbon source such as C₂H₄, C₃H₆, or CH₄ over the catalyst agglomerates at appropriate growth conditions, the carbon nanotubes initiated from the nano-metal particles on the support (black dots in FIG. 5) will force the catalyst agglomerates expand as the carbon nanotubes grow longer. Ultimately, the final agglomerates of catalyst and carbon nanotubes are formed. The catalyst is not only effecting the catalytic growth but also impacting the microstructure and morphology of the final carbon nanotubes with diameters of 4-100 nm, and length of 0.5 to 1000 micron.

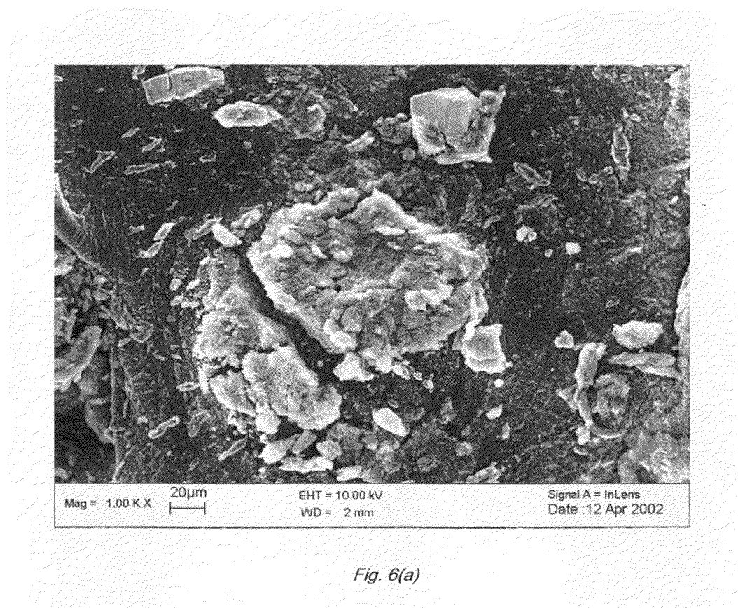

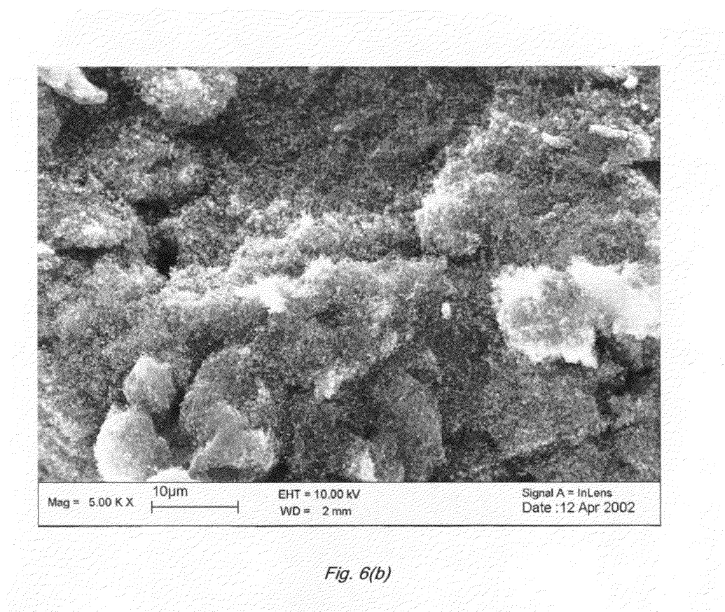

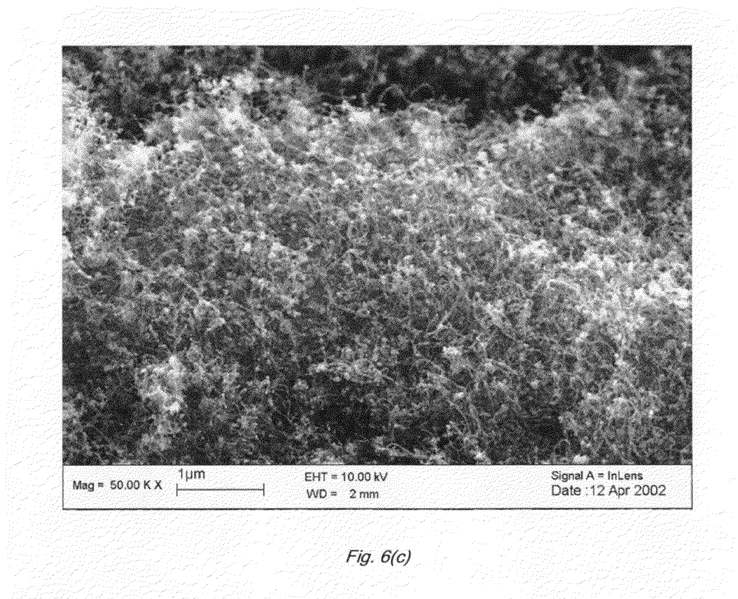

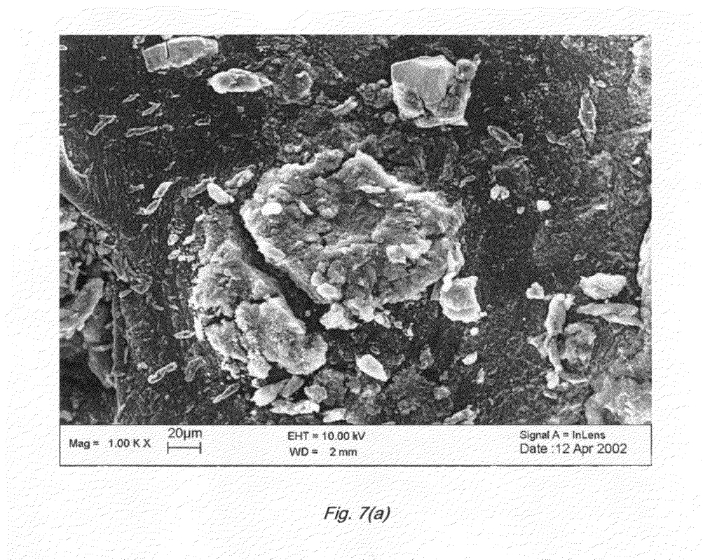

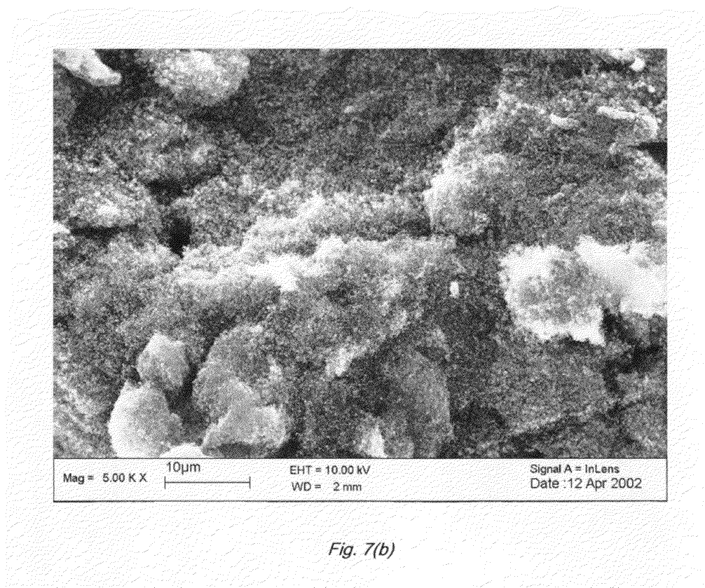

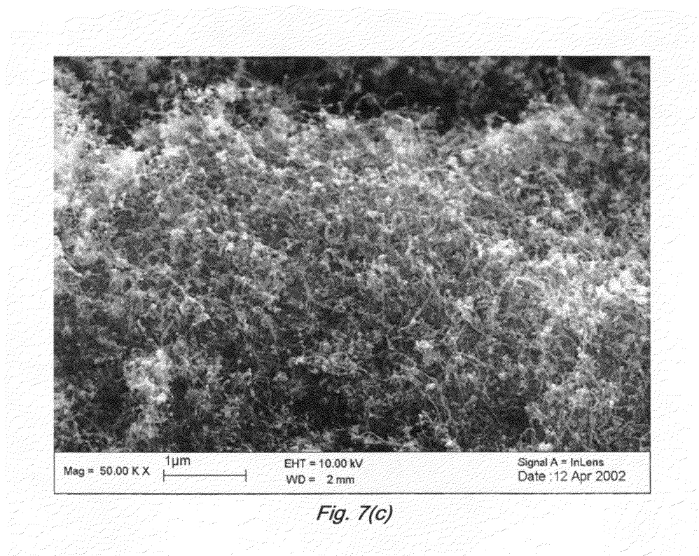

The cluster structure of carbon nanotube agglomerates has a major impact on the powder flow properties and dispersion inside a fluidized bed reactor. On the macro scale, the agglomerates of carbon nanotubes are black powder with a bulk density of 50˜200 kg/m³, much lower than the graphite material density of 2,200 kg/m³, indicating that carbon nanotubes agglomerates are in a much loose aggregation form. FIGS. 6 and 7 are the carbon nanotube agglomerate images under scanning electron microscopy for two samples. In order to facilitate the explanation, aggregation of small agglomerates will be called as “simple agglomerate”, and re-aggregation of simple agglomerates together to form large aggregates called as “composite agglomerate” or “complex agglomerate.”

FIG. 6 shows carbon nanotube agglomerates under different magnification for sample 1. In FIG. 6a, the dark background is from the sample holder while the carbon nanotube agglomerates are the rough spherical particles with an average diameter of about 100 microns. The density of the agglomerates is from 50 to 200 kg/m³. With a higher magnification (notice the scale bar in each image), the large spherical agglomerates is actually a composite agglomerate with hundreds of nano simple agglomerate in an adhesion formation as shown in FIG. 6b by looking into the large agglomerates. FIG. 6c shows that the entanglement of interwoven carbon nanotubes within the nano-sized simple agglomerates. The loose agglomerate appearance in FIG. 6a indicates that the aggregation strength of the composite agglomerates is not very high due to small aspect ration (length vs. diameter of carbon nanotubes) resulting in weak winding between carbon nanotubes. Those loose characteristics limit the growth or size of the agglomerates, thus helping the stability of the fluidized operation during carbon nanotube growth.

A different sample 2 also shows a multi-level agglomerate structure of carbon nanotubes, as shown in FIG. 7. As comparing to sample 1, this sample shows slightly different morphology, mostly due to the variation in initial catalyst formation or in growth process conditions. The dimension of the carbon nanotube agglomerates ranges from 20 microns to few 100 microns. The major difference is that simple and composite agglomerates in sample 2 have irregular shapes. The average volume diameter of the simple agglomerates is on the order of microns while that of composite agglomerate is on order of the tens of microns. High-magnification scanning electron microscope shows that the agglomerates are rich in carbon nanotubes, similar to fluffy cotton (FIG. 7c).

Samples 1 and 2 can be made with similar process and catalyst. However, depending on the initial catalyst morphology or changes in morphology due to collisions in the reactors, one may get either sample 1 or sample 2.

Carbon nanotubes are nano-materials, similar to other nano-particles, which will attract to each other as a result of van der Waals force to reduce the system's total surface energy, forming the agglomerates. On the other hand, since carbon nanotubes are one-dimensional materials, weaving around each other is an important reason for the agglomerate formation. Although the two kinds of carbon nanotube samples (1 and 2) have different morphology and sizes, they do have the same characteristics. First, both have multi-stage agglomerate structures: simple and composite agglomerate. Second, both are loose agglomerates. There is a lot of empty space between simple agglomerates and carbon nanotubes. Without being bound by the theory, the low bulk density of the carbon nanotube agglomerates is related to the loose structure and empty space. The loose structure not only effectively reduces the powder bulk density, making them more easily fluidized in the gas phase, but also enables self-regulation and control of the agglomerate size with self-assembling of the aggregation from simple agglomerates to multi-level complex agglomerates. With the size of the agglomerates under control, it ensures the stable growth process of carbon nanotube fluidization.

While the aggregation of nano materials is a known phenomenon, formation of loose agglomerate structure is unique and unexpected and requires specific conditions since not all nano-materials will form a loose agglomerate structure. Nano-catalysts should have the desired agglomerate structure and properties for nano-agglomerate fluidized bed process. The required structure of the catalyst agglomerates is not only for its own fluidization in a gas phase but also to maintain the fluidized operation of agglomerates after growth of large amount of carbon nanotubes on the catalysts. The formation of loose, stable, appropriate-size agglomerates is the key for realization of fluidization of nano materials. The loose structure effectively reduces the viscous forces between nano-powders and the density of the agglomerates, thus, providing an opportunity for the gas-solid system fluidization. With respect to the carbon nanotube growth with a fluidized bed reactor, the formation of the nano-agglomerates of the catalysts and carbon nanotubes allows easy process control (e.g., the control of temperature, flow, growth rate, and amount of catalysts), and ensures the uniform carbon nanotube growth within the whole reactor. Combining the fluidized bed with the nano-agglomerates provides a means for mass production of carbon nanotubes with a scalable process.

The carbon nanotubes prepared using the methods and carbon nanotube agglomerates of the present invention can have multi-wall, single wall, double-wall

Surprisingly, the carbon nanotubes produced using the fluidized bed with the carbon nanotube agglomerates are highly crystalline, have a purity of greater than 96% and a yield of greater than >26 g/per gram of catalyst. Moreover, in the presence of carbon nanotube agglomerates, the reaction is under a dense phase fluidization and there is no deposit of amorphous carbons. Carbon nanotubes of various structures and morphologies can be prepared using the methods and carbon nanotube agglomerates of the present invention. For example, high purity (>96%) carbon nanotubes with single-wall, double-wall, multi-wall or a mixture thereof can be prepared.

Although the foregoing invention has been described in some detail by way of illustration and example for purposes of clarity of understanding, one with skill in the art will appreciate that certain changes and modifications may be practiced within the scope of the appended claims. In addition, each reference provided herein is incorporated by reference in its entirety to the same extent as if each reference was individually incorporated by reference.

What is claimed is:

1. A carbon nanotube agglomerate comprising:
a plurality of transition metal nanoparticles;
a solid support, wherein said plurality of metal nanoparticles and said support are combined to form a plurality of catalyst nano-agglomerates; and
a plurality of carbon nanotubes deposited on said plurality of catalyst nano-agglomerates.

2. The carbon nanotube agglomerate of claim 1, wherein said plurality of carbon nanotubes deposited on said plurality of catalyst nano-agglomerates in a fluidized-bed reactor.

3. The carbon nanotube agglomerate of claim 1, wherein said plurality of carbon nanotubes is deposited on said plurality of catalyst nano-agglomerates through covalent bonding to said plurality of metal nanoparticles.

4. The carbon nanotube agglomerate of claim 1, fluidizing in a fluidized-bed reactor, wherein a superficial gas velocity of about 0.005 to 2 m/s is maintained.

5. The carbon nanotube agglomerate of claim 1, fluidizing in a fluidized-bed reactor, wherein a bed density of about 20 to 800 kg/m³ is maintained.

6. The carbon nanotube agglomerate of claim 1, fluidizing in a fluidized-bed reactor, wherein a gas space velocity of about 5 to 10,000 h⁻¹ is maintained.

7. The carbon nanotube agglomerate of claim 1, fluidizing in a fluidized-bed reactor, wherein a superficial gas velocity of about 0.005 to 2 m/s, a space velocity of 5 to 10,000 h⁻¹ and a bed density of about 20 to 800 kg/m³ are maintained.

8. The carbon nanotube agglomerate of claim 7, wherein the fluidized-bed reactor comprises a main reactor (1), a catalyst activation reactor (6), a gas distributor (2), a gas-solid separator (7) and a product degassing section (9), wherein the catalyst activation reactor (6) is connected to the main reactor (1), the gas distributor (2) is placed in the bottom of the main reactor (1), the gas-solid separator (7) is arranged at the top of the main reactor (1), the main reactor (1) is provided with heat exchange tubes (3) and means for feeding gases at its bottom, and the product degassing section (9) is connected to the main reactor (1) through a product outlet (5).

9. The carbon nanotube agglomerate of claim 1, having a diameter of about 1 μm to about 1000 μm.

10. The carbon nanotube agglomerate of claim 1, wherein said plurality of catalyst nano agglomerates has a diameter of about 1 μm to about 1000 μm.

11. The carbon nanotube agglomerate of claim 1, wherein the solid support is superfine glass beads, SiO₂, Al₂O₃ or carbon nanotubes.

12. The carbon nanotube agglomerate of claim 1, wherein said plurality of transition metal nanoparticles is formed from a transition metal oxide selected from the group consisting of Fe—Cu oxide, Ni—Cu oxide, Co—Mn oxide and Ni oxide.

13. The carbon nanotube agglomerate of claim 1, wherein the plurality of carbon nanotubes has a diameter from about 4 to about 100 nm.

14. The carbon nanotubes agglomerate of claim 1, wherein the carbon nanotubes agglomerate is formed in a nano-agglomerate fluidized bed reaction apparatus, which apparatus comprises a main reactor (1), a catalyst activation reactor (6), a gas distributor (2), a gas-solid separator (7) and a product degassing section (9), wherein the catalyst activation reactor (6) is connected to the main reactor (1), the gas distributor (2) is placed in the bottom of the main reactor (1), the gas-solid separator (7) is arranged at the top of the main reactor (1), the main reactor (1) is provided with heat exchange tubes (3) and means for feeding gases at its bottom, and the product degassing section (9) is connected to the main reactor (1) through a product outlet (5).

15. The carbon nanotube agglomerate of claim 1, wherein said plurality of carbon nanotubes comprises a plurality of multi-wall carbon nanotubes.

16. A carbon nanotube agglomerate comprising:
a plurality of transition metal nanoparticles, wherein said plurality of transition metal nanoparticles is formed from a transition metal oxide selected from the group consisting of Fe—Cu oxide, Ni—Cu oxide, Co—Mn oxide or Ni oxide;
a solid support selected from superfine glass beads, SiO₂, Al₂O₃ or carbon nanotubes, wherein said plurality of metal nanoparticles and said support are combined to form a plurality of catalyst nano agglomerates; and
a plurality of carbon nanotubes deposited on said plurality of catalyst nano-agglomerates in a fluidized-bed reactor.

17. The carbon nanotube agglomerate of claim 16, wherein said plurality of carbon nanotubes comprises a plurality of multi-wall carbon nanotubes.

18. A carbon nanotube agglomerate formed in a fluidized-bed reactor by contacting a plurality of transitional metal nanoparticles on a solid support with a carbon-source-gas comprising a gas of lower hydrocarbons having less than 7 carbon atoms, wherein a gas space velocity of about 5-10000 h⁻¹ and a bed density of about 20-800 kg/m³ are maintained.
